(19) United States
(12) Patent Application Publication
(10) Pub. No.: US 2022/0411711 A1
(43) Pub. Date: Dec. 29, 2022

(54) Oil-Containing Fiber-Polymer Self-Lubricating Composite Material and Preparation Method Thereof

(71) Applicant: Lanzhou Institute of Chemical Physics, Chinese Academy of Sciences, Lanzhou City (CN)

(72) Inventors: Xiaolong Wang, Lanzhou City (CN); Xing Xu, Lanzhou City (CN); Rui Guo, Lanzhou City (CN); Hongling Qin, Lanzhou City (CN); Feng Zhou, Lanzhou City (CN)

(73) Assignee: Lanzhou Institute of Chemical Physics, Chinese Academy of Sciences, Lanzhou City (CN)

(21) Appl. No.: 17/567,014

(22) Filed: Dec. 31, 2021

(30) Foreign Application Priority Data
Jun. 23, 2021 (CN) 202110695362.7

(51) Int. Cl. C10M 111/04; C10M 107/36; C10M 101/02; C10M 107/44; C10M 105/04; C10M 107/50; C10M 107/30

(52) U.S. Cl. CPC C10M 111/04; C10M 107/36; C10M 101/02; C10M 107/44; C10M 105/04; C10M 107/50; C10M 107/30; C10M 2203/1025; C10M 2209/123; C10M 2217/0453; C10M 2205/0206; C10M 2229/025; C10M 2209/1003; C10N 2050/08

(57) ABSTRACT

Disclosed is an oil-containing fiber-polymer self-lubricating composite material. The composite material includes a resin matrix and an oil-containing fiber dispersed in the resin matrix, wherein a mass ratio of the resin matrix to the oil-containing fiber is in the range of 100:(1-10); the resin matrix is a photocurable resin or a thermosetting resin; the oil-containing fiber comprises a natural fiber and a lubricating oil adsorbed in the natural fiber.

### CROSS REFERENCE TO RELATED APPLICATION

This application claims the benefit and priority of Chinese Patent Application No. 202110695362.7, filed on Jun. 23, 2021, the disclosure of which is incorporated by reference herein in its entirety as part of the present disclosure.

### TECHNICAL FIELD

The present disclosure relates to the technical field of lubricating materials, and in particular to an oil-containing fiber-polymer self-lubricating composite material and a preparation method thereof.

### BACKGROUND ART

An oil-containing self-lubricating polymer composite material has been widely used in engineering fields due to its excellent physical, chemical and mechanical properties, such as low friction, maintenance-free, portability, high specific strength, corrosion resistance, good elasticity, and convenient molding. The oil-containing self-lubricating polymer composite material (such as porous polyimide, foamed polyurethane) is generally formed by taking a material with pores as a matrix, filling the pores with a lubricating oil, and taking the pores filled with the lubricating oil as oil storage medium units. These pores are mainly formed by high-temperature sintering, a template method, additive manufacturing and other processing technologies. The lubricating oil in the pores of the composite material is released onto surfaces of a friction pair under the action of a load, thereby realizing a self-lubricating effect.

High porosity and oil storage capacity are required for polymer composite material with excellent self-lubricating properties. However, with the increase of porosity, the mechanical properties (such as compressive strength) and oil retention rate of the composite material would decrease.

### SUMMARY

In view of this, an object of the present disclosure is to provide an oil-containing fiber-polymer self-lubricating composite material and a preparation method thereof. The oil-containing fiber-polymer self-lubricating composite material according to the present disclosure has good oil retention rate and compressive strength while a good self-lubricating performance.

In order to realize the aforementioned object of the present disclosure, the present disclosure provides the following technical solutions.

The present disclosure provides an oil-containing fiber-polymer self-lubricating composite material, including a resin matrix and an oil-containing fiber dispersed in the resin matrix,

wherein a mass ratio of the resin matrix to the oil-containing fiber is in the range of 100:(1-10);

the resin matrix is a photocurable resin or a thermosetting resin;

the oil-containing fiber comprises a natural fiber and a lubricating oil adsorbed in the natural fiber.

In some embodiments, the photocurable resin is one or more selected from the group consisting of acrylic acid resin, vinyl polymer, vinyl ether polymer, polyurethane resin, and epoxy resin.

In some embodiments, the thermosetting resin is one or more selected from the group consisting of polyurethane resin, epoxy resin, vinyl ester resin, and silicone resin.

In some embodiments, the natural fiber is one or more selected from the group consisting of a cotton fiber, a kapok fiber, and a hemp fiber;

the natural fiber has a diameter of 5-20 μm and a length of 1-10 cm.

In some embodiments, the lubricating oil is one or more selected from the group consisting of liquid paraffin, silicone oil, and polyalpha-olefin PAO10.

The present disclosure provides a method for preparing the aforementioned oil-containing fiber-polymer self-lubricating composite material, including the following steps:

under the condition that the resin matrix is a photocurable resin, mixing a precursor compound monomer of the photocurable resin, a photocuring adjuvant, and an oil-containing fiber, and subjecting the resulting mixture to an ultraviolet curing, to obtain the oil-containing fiber-polymer self-lubricating composite material; or

under the condition that the resin matrix is a thermosetting resin, mixing a precursor compound monomer of the thermosetting resin with an oil-containing fiber, and subjecting the resulting mixture to a thermal curing, to obtain the oil-containing fiber-polymer self-lubricating composite material.

In some embodiments, the oil-containing fiber is prepared by a process comprising

impregnating a natural fiber in a lubricating oil, and subjecting the resulting mixture to a solid-liquid separation to obtain the oil-containing fiber,

wherein impregnating a natural fiber in a lubricating oil is performed for 10-30 min.

In some embodiments, the photocuring adjuvant includes a reactive diluent and a photoinitiator, and a mass ratio of the precursor compound monomer of the photocurable resin, the reactive diluent, and the photoinitiator is in the range of (10-90):(5-15):(0.5-1.5).

In some embodiments, ultraviolet light for the ultraviolet curing has a wavelength of 250-420 nm, and an intensity of 30-50 mW/cm², and the ultraviolet curing is preformed for 10-30 min.

In some embodiments, the thermocuring is conducted at a temperature of 25-150° C. for 20-40 min.

The present disclosure provides an oil-containing fiber-polymer self-lubricating composite material, including a resin matrix and an oil-containing fiber dispersed in the resin matrix, wherein a mass ratio of the resin matrix to the oil-containing fiber is in the range of 100:(1-10); the resin matrix is a photocurable resin or a thermosetting resin; and the oil-containing fiber includes a natural fiber and a lubricating oil adsorbed in the natural fiber. Under the actions of hydrogen bonds and capillary force, the natural fiber has good oil absorbency. In the present disclosure, a natural fiber impregnated with a lubricating oil is dispersed in the resin matrix. On one hand, the oil-containing fiber could act as an oil storage medium unit; in a friction process, due to the compression and shearing actions of friction counterparts, a polymer shell on a surface of the fiber is broken, and plastical deformation occurs at the friction interface of the sample; with the progress of sliding friction, the lubricating oil in the oil-containing fiber is squeezed out and spreads into a lubricating oil film with a certain thickness on the worn surface, thereby realizing a self-lubricating function. On the other hand, a network structure could be built in the polymer from the oil-containing fiber, thereby improving compression resistance of the composite material, which is conducive to reduced interfacial deformation. Meanwhile, due to the sealing effect of the polymer on the fiber, the lubricating oil is firmly locked in the resin matrix, thereby having a good oil retention rate. The results of Examples show that the oil-containing fiber-polymer self-lubricating composite material according to the present disclosure has an average friction coefficient of 0.033 under a load of 5 N, and an average friction coefficient of 0.062 under a load of 13 N, a compressive strength after 5 cycles of 1.5 MPa, and an oil retention rate within 30 min close to 100%.

The present disclosure provides a method for preparing the aforementioned oil-containing fiber-polymer self-lubricating composite material. In the present disclosure, the oil-containing fiber is mixed with a precursor, and the resulting mixture is subjected to an ultraviolet curing or a thermal curing to prepare the oil-containing fiber-polymer self-lubricating composite material. The method has simple operation and low cost, and thus is suitable for industrial mass production.

### BRIEF DESCRIPTION OF THE DRAWINGS

FIG. 1 is a scanning electron microscope (SEM) image of a cross section of the oil-containing fiber-polymer self-lubricating composite material prepared in Example 1 of the present disclosure.

FIG. 2 is a diagram showing an optical topography of a surface of the oil-containing fiber-polymer self-lubricating composite material prepared in Example 1 of the present disclosure.

FIG. 3 is a SEM image of the surface of the oil-containing fiber-polymer self-lubricating composite material prepared in Example 1 of the present disclosure.

### DETAILED DESCRIPTION OF THE EMBODIMENTS

The present disclosure provides an oil-containing fiber-polymer self-lubricating composite material, including a resin matrix and an oil-containing fiber dispersed in the resin matrix, wherein a mass ratio of the resin matrix to the oil-containing fiber is in the range of 100:(1-10);

the resin matrix is a photocurable resin or a thermosetting resin;

the oil-containing fiber comprises a natural fiber and a lubricating oil adsorbed in the natural fiber.

In some embodiments of the present disclosure, the photocurable resin is one or more selected from the group consisting of acrylic acid resin, vinyl polymer, vinyl ether polymer, polyurethane resin, and epoxy resin. In the present disclosure, the photocurable resin is obtained by photocuring a precursor compound monomer. In some embodiments, the precursor compound monomer is one or more selected from the group consisting of an acrylic compound, a vinyl compound, a vinyl ether compound, a polyurethane compound, and an epoxy compounds, and preferably one or more selected from the group consisting of polyurethane acrylate, bifunctional aliphatic polyurethane acrylate, polyethylene glycol diacrylate, bisphenol A epoxy resin, monofunctional aliphatic polyurethane acrylate, and methacrylic polyamide acid.

In the present disclosure, there is no special requirement on the source of the aforementioned precursor compound monomer, and conventional commercially-available ones of the aforementioned components in the art may be used. As a specific embodiment of the present disclosure, the polyurethane acrylate is of the model of 8413 and purchased from Allnex Resins China Co., Ltd.; the bifunctional aliphatic polyurethane acrylate is of the model of 6282 and purchased from Shanghai Guangyi Chemical Co., Ltd., China; the polyethylene glycol diacrylate is of the model of PEG400DA and purchased from Tianjin Chemical Reagent Research Institute Co., Ltd., China; and the monofunctional aliphatic polyurethane acrylate is of the model of 1122TF and purchased from Shanghai RAHN Co., Ltd., China.

In some embodiments of the present disclosure, the thermosetting resin is one or more selected from the group consisting of polyurethane resin, epoxy resin, vinyl ester resin, and silicone resin. In the present disclosure, the thermosetting resin is obtained by thermocuring a precursor compound monomer. In some embodiments of the present disclosure, the precursor compound monomer of the thermosetting resin is one or more selected from the group consisting of a polyurethane prepolymer, an epoxy resin prepolymer, bisphenol A epoxy vinyl resin, and polyalkyl silicone resin. In some embodiments, the polyurethane prepolymer is a monocomponent polyurethane prepolymer. In the present disclosure, the polyurethane prepolymer is a reactive semi-finished product prepared from polyisocyanate and polyol.

In the present disclosure, there is no special requirement on the source of the aforementioned components, and conventional commercially-available ones of the aforementioned components in the art may be used.

In some embodiments of the present disclosure, the natural fiber is one or more selected from the group consisting of a cotton fiber, a kapok fiber, and a hemp fiber. In some embodiments, the hemp fiber is a flax fiber. In some embodiments of the present disclosure, the natural fiber has a diameter of 5-20 μm, and preferably 10-15 μm; a length of 1-10 cm, and preferably 4-8 cm.

In some embodiments of the present disclosure, the lubricating oil is one or more selected from the group consisting of liquid paraffin, silicone oil, and polyalpha-olefin PAO10. In some embodiments, the lubricating oil has a viscosity of 3-600 cps at room temperature, preferably 20-400 cps, and further preferably 50-300 cps. In the present disclosure, there is no special requirement on the source of the lubricating oil, and conventional commercially-available ones of the aforementioned components in the art may be used. As a specific embodiment of the present disclosure, the liquid paraffin is purchased from Tianjin Chemical Reagent Research Institute Co., Ltd., China; the silicone oil is purchased from Shanghai Yuanye Bio-Technology Co., Ltd., China; and the polyalpha-olefin PAO10 is purchased from Exxon Mobil Corporation.

In some embodiments of the present disclosure, a mass ratio of the resin matrix to the oil-containing fiber is in the range of 100:(1-10), preferably 100:(2-8), and further preferably 100:(4-6).

The present disclosure provides a method for preparing the aforementioned oil-containing fiber-polymer self-lubricating composite material, including the following steps:

under the condition that the resin matrix is a photocurable resin, mixing a precursor compound monomer of the photocurable resin, a photocuring adjuvant, and an oil-containing fiber, and subjecting the resulting mixture to an ultraviolet curing, to obtain the oil-containing fiber-polymer self-lubricating composite material; or

under the condition that the resin matrix is a thermosetting resin, mixing a precursor compound monomer of the thermosetting resin with an oil-containing fiber, and subjecting the resulting mixture to a thermal curing, to obtain the oil-containing fiber-polymer self-lubricating composite material.

In the present disclosure, the oil-containing fiber is prepared by a process including

impregnating a natural fiber in a lubricating oil, and subjecting the resulting mixture to a solid-liquid separation to obtain the oil-containing fiber. In some embodiments of the present disclosure, the process further includes before impregnating a natural fiber in a lubricating oil, drying the natural fiber. In some embodiments of the present disclosure, the drying is conducted at a temperature of 50-80° C., and preferably 60-70° C. In some embodiments, the drying is conducted for 1-2 h, and preferably 1.5 h.

In some embodiments of the present disclosure, a mass ratio of the natural fiber to the lubricating oil is 1:(1-10), preferably 1:(2-8), and further preferably 1:(4-6). In the present disclosure, there is no special requirement on the means for mixing, and means for mixing well known to those skilled in the art may be used, in particular for example stirring for mixing.

In some embodiments of the present disclosure, impregnating a natural fiber in a lubricating oil is conducted at a temperature of 10-35° C., and preferably 20-30° C. In some embodiments, impregnating a natural fiber in a lubricating oil is conducted for 10-30 min, and preferably 15-25 min, and further preferably 20 min. In the present disclosure, there is no special requirement on the means for the solid-liquid separation, and means for the solid-liquid separation well known to those skilled in the art may be used as long as the impregnated oil-containing fiber could be separated from the lubricating oil, for example a filtration.

Under the condition that the resin matrix is a photocurable resin, a precursor compound monomer of the photocurable resin, a photocuring adjuvant, and an oil-containing fiber are mixed, and the resulting mixture is subjected to an ultraviolet curing to obtain the oil-containing fiber-polymer self-lubricating composite material. In some embodiments of the present disclosure, the photocuring adjuvant includes a reactive diluent and a photoinitiator. In some embodiments of the present disclosure, the reactive diluent is one or more selected from the group consisting of acrylic acid, styrene, N-vinyl pyrrolidone, and isobornyl methacrylate. In the present disclosure, the reactive diluent is to dissolve the precursor compound monomer of the photocurable resin, such that a crosslinking reaction takes place.

In some embodiments of the present disclosure, the photoinitiator is a compound having activity under the irradiation of ultraviolet light having a wavelength of 250-420 nm, and in particular preferably one or more selected from the group consisting of benzoin dimethyl ether, phenyl bis(phosphine oxide), dibenzoyl peroxide, ethyl trimethyl benzoyl phosphonate, tri aryl sulfonium hexafluoroantimonate, and 2-hydroxy-4′-(2-hydroxyethoxy)-2-methylphenylacetone. In the present disclosure, the photoinitiator is to absorb ultraviolet rays for a photocuring reaction.

In some embodiments of the present disclosure, a mass ratio of the precursor compound monomer of the photocurable resin, the reactive diluent, and the photoinitiator is in the range of (10-90):(5-15):(0.5-1.5), preferably (40-80):(8-12):(0.8-1.2), and further preferably 90: 10:1. In the present disclosure, there is no special requirement on the means for mixing, and means for mixing well known to those skilled in the art may be used, in particular for example mixing under stirring.

In some embodiments of the present disclosure, after the mixing, the obtained mixture is degassed. In some embodiments of the present disclosure, the means for degassing is heating the resulting mixture to 50-60° C. and holding at the temperature. In some embodiments of the present disclosure, a temperature rising rate during the heating is in the range of 5-10° C./min, and preferably 6-8° C./min. In some embodiments, the resulting mixture was held at the temperature for 20-40 min, and preferably 30 min.

In some embodiments of the present disclosure, ultraviolet light for the ultraviolet curing has a wavelength of 250-420 nm, and preferably 300-400 nm, and a intensity of 30-50 mW/cm², and preferably 40 mW/cm². In some embodiments, the ultraviolet curing is performed for 10-30 min, and preferably 15-25 min.

Under the condition that the resin matrix is a thermosetting resin, a precursor compound monomer of the thermosetting resin is mixed with an oil-containing fiber, and the resulting mixture is subjected to a thermal curing to obtain the oil-containing fiber-polymer self-lubricating composite material. In the present disclosure, there is no special requirement on the means for mixing and any means for mixing well known to those skilled in the art may be used. In some embodiments of the present disclosure, the thermal curing is conducted at a temperature of 25-150° C., preferably 50-120° C., and further preferably 70-100° C. In some embodiments, the thermal curing is conducted for 20-40 min, preferably 25-35 min, and further preferably 30 min. In some embodiments of the present disclosure, the temperature rises to the thermocuring temperature at a rising rate of 1-5° C./min, and preferably 2-4° C./min.

The oil-containing fiber-polymer self-lubricating composite material and the preparation method thereof according to the present disclosure will be described in detail in connection with the following examples, but they should not be construed as limiting the claimed scope of the present disclosure.

### Example 1

A cotton fiber with a length of 5 cm and a diameter of 10 μm was heated to 80° C. and dried for 1 h to remove the moisture contained in the fiber. The liquid paraffin was mixed with the cotton fiber in a mass ratio of 8:1, and the resulting mixture was stood for 30 min, obtaining the oil-containing fiber.

The raw materials for preparing the photocurable resin were as follows: in parts by weight, 3 parts of polyurethane acrylate, 2 parts of bifunctional aliphatic polyurethane acrylate, 2 parts of hydroxyethyl methacrylate, 1 part of polyethylene glycol diacrylate, 1 part of monofunctional aliphatic polyurethane acrylate, 1 part of isobornyl methacrylate as a reactive diluent, and 0.005 part of phenyl bis(phosphine oxide) as a photoinitiator.

The oil-containing fiber was mixed with the raw materials for preparing the photocurable resin in a mass ratio of 2:5, and the resulting mixture was loaded into a mold. The mold was heated in an oven from room temperature to 50° C. at a temperature rising rate of 5° C./min, and held at this temperature for 30 min to remove bubbles. The degassed mixture was put into an ultraviolet curing box and cured under the irradiation of ultraviolet light having a wavelength of 250 nm and an exposure intensity of 50 mW/cm² for 20 min, obtaining the oil-containing fiber-polymer self-lubricating composite material.

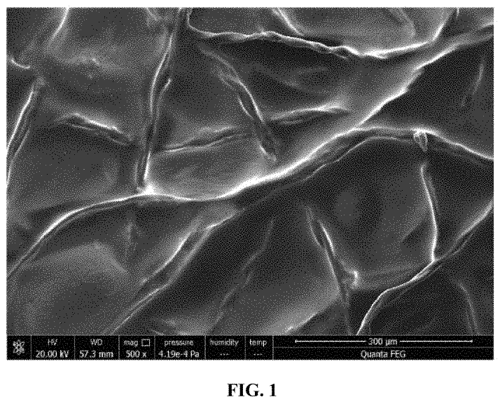

A SEM image of a cross section of the obtained oil-containing fiber-polymer self-lubricating composite material is shown in FIG. 1. It can be seen from FIG. 1 that the oil-containing fiber is randomly distributed in the resin matrix to form a network structure.

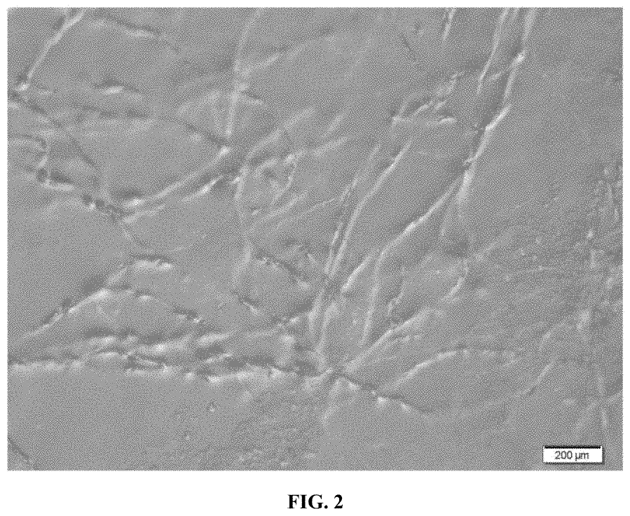

Optical topography of a surface of the obtained oil-containing fiber-polymer self-lubricating composite material is shown in FIG. 2. It can be seen from FIG. 2 that the oil-containing fiber exists on the surface of the resin matrix.

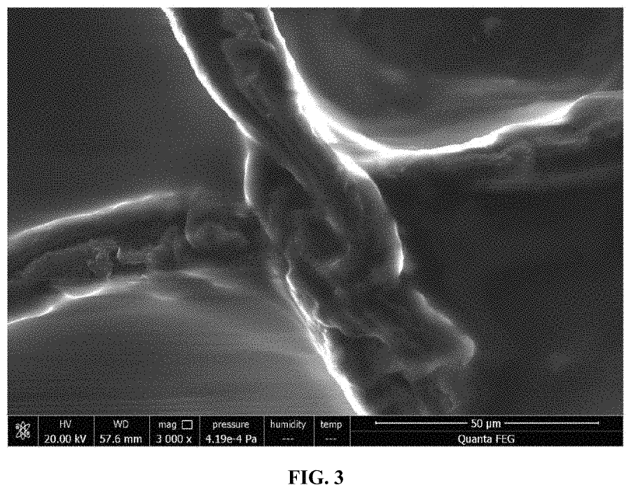

A SEM image of the fiber surface of the obtained oil-containing fiber-polymer self-lubricating composite material is shown in FIG. 3. It can be seen from FIG. 3 that the oil-containing fiber is covered by the resin.

### Example 2

A kapok fiber with a length of 2 cm and a diameter of 15 μm was heated to 80° C. and dried for 1 h to remove the moisture contained in the fiber. The liquid paraffin was mixed with the kapok fiber in a mass ratio of 5:1, and the resulting mixture was stood for 20 min, obtaining the oil-containing fiber.

The raw materials for preparing the photocurable resin were as follows: in parts by weight, 10 parts of polyethylene glycol diacrylate, 5 parts of 4-acryloylmorpholine as a reactive diluent and 0.5 part of ethyl trimethyl benzoyl phosphonate as a photoinitiator.

The oil-containing fiber was mixed with the raw materials of for preparing the photocurable resin in a mass ratio of 1:5, and the resulting mixture was loaded into a mold. The mold was heated in an oven from room temperature to 50° C. at a temperature rising rate of 5° C./min, and held at this temperature for 30 min to remove bubbles. The degassed mixture was put into an ultraviolet curing box and cured under the irradiation of ultraviolet light having a wavelength of 320 nm and an exposure intensity of 30 mW/cm² for 30 min, obtaining the oil-containing fiber-polymer self-lubricating composite material.

### Example 3

A flax fiber with a length of 8 cm and a diameter of 10 μm was heated to 80° C. and dried for 1 h to remove the moisture contained in the fiber. PAO10 was mixed with the flax fiber in a mass ratio of 5:1, and the resulting mixture was stood for 20 min, obtaining the oil-containing fiber.

The raw materials for preparing the photocurable resin were as follows: in parts by weight, 3 parts of polyurethane acrylate, 2 parts of polyethylene glycol diacrylate, 2 parts of triethylene glycol, 1 part of hydroxyethyl methacrylate as a reactive diluent and 0.08 part of 2-hydroxy-4′-(2-hydroxyethoxy)-2-methylphenylacetone as a photoinitiator.

The oil-containing fiber was mixed with the raw materials for preparing the photocurable resin in a mass ratio of 1:3, and the resulting mixture was loaded into a mold. The mold was heated in an oven from room temperature to 50° C. at a temperature rising rate of 5° C./min, and held at this temperature for 30 min to remove bubbles. The degassed mixture was put into an ultraviolet curing box and cured under the irradiation of ultraviolet light having a wavelength of 420 nm and an exposure intensity of 40 mW/cm² for 10 min, obtaining the oil-containing fiber-polymer self-lubricating composite material.

### Example 4

A flax fiber with a length of 1 cm and a diameter of 10 μm was heated to 80° C. and dried for 1 h to remove the moisture contained in the fiber. Silicone oil was mixed with the flax fiber in a mass ratio of 5:1, and the resulting mixture was stood for 20 min, obtaining the oil-containing fiber.

The raw materials for preparing the photocurable resin were as follows: in parts by weight, 10 parts of bisphenol A epoxy resin (E51), 5 parts of propylene oxide butyl ether as a reactive diluent, and 0.5 parts of triarylsulfonium hexafluoroantimonate as a photoinitiator.

The oil-containing fiber was mixed with the raw materials for preparing the photocurable resin in a mass ratio of 1:5, and the resulting mixture was loaded into a mold. The mold was heated in an oven from room temperature to 50° C. at a temperature rising rate of 5° C./min, and held at this temperature for 30 min to remove bubbles. The degassed mixture was put into an ultraviolet curing box and cured under the irradiation of ultraviolet light having a wavelength of 400 nm and an exposure intensity of 35 mW/cm² for 25 min, obtaining the oil-containing fiber-polymer self-lubricating composite material.

### Example 5

A cotton fiber with a length of 5 cm and a diameter of 10 μm was heated to 80° C. and dried for 1 h to remove the moisture contained in the fiber. Silicone oil was mixed with the cotton fiber in a mass ratio of 8:1, and the resulting mixture was stood for 20 min, obtaining the oil-containing fiber.

The oil-containing cotton fiber was mixed with a bisphenol A epoxy resin prepolymer in a mass ratio of 1:6, and the resulting mixture was loaded into a mold. The mold was heated in an oven from room temperature to 80° C. at a temperature rising rate of 5° C./min, and held at this temperature for 30 min for curing, obtaining the oil-containing fiber-polymer self-lubricating composite material.

### Comparative Example 1

This example was performed according to Example 1, except that no oil-containing fiber was added, obtaining a photocurable resin.

### Comparative Example 2

This example was performed according to Example 5, except that no oil-containing fiber was added, obtaining a thermosetting resin.

### Performance Test

### (1) Friction Test

The products of Examples 1-5 and Comparative Examples 1-2 were subjected to a friction test under the following conditions: a load of 5 N, 10 N, and 13 N, a frequency of 2.5 Hz, a diameter of the counterpart steel ball of 6 mm, wherein the friction coefficient test was repeated for at least three times, and an average value was taken. The results are shown in Table 1.

TABLE 1
Friction test results of Examples
1-3 and Comparative Examples 1-2

| | Weight ratio of | | | Average | |
|---|---|---|---|---|---|
| | fiber to | | | friction | Standard |
| Item | lubricating oil | Load | | coefficient | Deviation |
| Example 1 | 8:1 | 5 | N | 0.033 | 0.0017 |
| | | 10 | N | 0.045 | 0.0027 |
| | | 13 | N | 0.062 | 0.0036 |
| Example 2 | 5:1 | 5 | N | 0.098 | 0.0023 |
| | | 10 | N | 0.125 | 0.0035 |
| | | 13 | N | 0.192 | 0.0046 |
| Example 3 | 5:1 | 5 | N | 0.089 | 0.0015 |
| | | 10 | N | 0.117 | 0.0045 |
| | | 13 | N | 0.159 | 0.0048 |
| Example 4 | 5:1 | 5 | N | 0.078 | 0.0052 |
| | | 10 | N | 0.116 | 0.0062 |
| | | 13 | N | 0.215 | 0.0078 |
| Example 5 | 8:1 | 5 | N | 0.046 | 0.0022 |
| | | 10 | N | 0.057 | 0.0038 |
| | | 13 | N | 0.068 | 0.0042 |
| Comparative | 0 | 5 | N | 0.8748 | 0.1245 |
| Example 1 | | 10 | N | 0.992 | 0.0978 |
| | | 13 | N | 0.997 | 0.122 |
| Comparative | 0 | 5 | N | 0.815 | 0.1098 |
| Example 2 | | 10 | N | 0.921 | 0.0875 |
| | | 13 | N | 0.955 | 0.1351 |

It can be seen from Table 1 that the oil-containing fiber-polymer self-lubricating composite material according to the present disclosure has a good self-lubricating performance.

### (2) Cyclic Compression Test

The products of Examples 1-5 and Comparative Examples 1-2 were subjected to a cyclic compression test according to GB/T 1041-1992, with a loading speed of 5 mm/min and a maximum strain controlled at 3.5%. The friction test was carried out with an ANTON PAAR ball-on-disc reciprocating friction machine, and each counterpart was made of a GCr15 material. The results of the cyclic compression test are shown in Table 2.

TABLE 2
Cyclic compression test results of Examples
1-3 and Comparative Examples 1-2

| | | Maximum compressive |
|---|---|---|
| Item | Number of cycles | strength/Mpa |
| Example 1 | 5 | 1.52 |
| Example 2 | 5 | 0.98 |
| Example 3 | 5 | 0.74 |
| Example 4 | 5 | 0.78 |
| Example 5 | 5 | 1.25 |
| Comparative | 5 | 0.34 |
| Example 1 | | |
| Comparative | 5 | 0.68 |
| Example 2 | | |

It can be seen from Table 2 that the oil-containing fiber-polymer self-lubricating composite material according to the present disclosure has good compressive strength.

### (3) Test of Oil Content and Oil Retention Rate

The products of Examples 1-5 and Comparative Examples 1-2 were tested for the oil content and oil retention rate. The test method was as follows: the test was carried out on a high-speed centrifuge, and the composite materials before and after the centrifugation were weighed to obtain a mass difference. A rotation speed for oil rejection was 3,000 r/min, and the test time was 30 min. The sample was weighed, and the change of oil content was calculated. The oil content rate w of the self-lubricating material was calculated by equation 1:

$$ψ = \frac{{m}_{Oil}}{{m}_{Toll}} \times 100 \% , \qquad equation 1$$

in which, mₒᵢₗ refers to the weight of lubricating oil, m_{Toll} refers to the total mass of the sample. The oil retention rate ξ after centrifugal oil rejection was calculated by the following equation 2:

$$ξ = 1 - \frac{{m}_{before} - {m}_{after}}{{m}_{before}} \times 100 \% , \qquad equation 2$$

in which, m_{before} ore refers to the mass of the sample before centrifugal oil rejection, and mₐₜₑᵣ refers to the mass of the sample after centrifugal oil rejection.

The results are shown in Table 3.

TABLE 3
Oil contents and oil retention rates
of Examples 1-5 at different times

| | Oil content (%) | Oil retention rate (%) |
|---|---|---|
| Example 1 | 29.62 | 100 |
| Example 2 | 13.88 | 100 |
| Example 3 | 20.83 | 100 |
| Example 4 | 13.88 | 100 |
| Example 5 | 12.69 | 100 |

It can be seen from Table 3 that the oil-containing fiber-polymer self-lubricating composite material according to the present disclosure has good oil content and oil retention rate.

The above description is only preferred embodiments of the present disclosure. It should be pointed out that, for those of ordinary skills in the art, several improvements and modifications could be made without departing from the principle of the present disclosure. These improvements and modifications should also be considered as falling within the claimed scope of the present disclosure.

1. An oil-containing fiber-polymer self-lubricating composite material, comprising a resin matrix and an oil-containing fiber dispersed in the resin matrix,
wherein a mass ratio of the resin matrix to the oil-containing fiber is in the range of 100:(1-10);
the resin matrix is a photocurable resin or a thermosetting resin;
the oil-containing fiber comprises a natural fiber and a lubricating oil adsorbed in the natural fiber, and
the natural fiber has a diameter of 5-20 μm and a length of 1-10 cm.

2. The oil-containing fiber-polymer self-lubricating composite material as claimed in claim 1, wherein the photocurable resin is one or more selected from the group consisting of acrylic acid resin, vinyl polymer, vinyl ether polymer, polyurethane resin, and epoxy resin.

3. The oil-containing fiber-polymer self-lubricating composite material as claimed in claim 1, wherein the thermosetting resin is one or more selected from the group consisting of polyurethane resin, epoxy resin, vinyl ester resin, and silicone resin.

4. The oil-containing fiber-polymer self-lubricating composite material as claimed in claim 1, wherein the natural fiber is one or more selected from the group consisting of a cotton fiber, a kapok fiber, and a hemp fiber.

5. The oil-containing fiber-polymer self-lubricating composite material as claimed in claim 1, wherein the lubricating oil is one or more selected from the group consisting of liquid paraffin, silicone oil, and polyalpha-olefin PAO10.

6. A method for preparing the oil-containing fiber-polymer self-lubricating composite material as claimed in claim 1, comprising
under the condition that the resin matrix is a photocurable resin, mixing a precursor compound monomer of the photocurable resin, a photocuring adjuvant, and an oil-containing fiber, and subjecting the resulting mixture to an ultraviolet curing, to obtain the oil-containing fiber-polymer self-lubricating composite material; or
under the condition that the resin matrix is a thermosetting resin, mixing a precursor compound monomer of the thermosetting resin with an oil-containing fiber, and subjecting the resulting mixture to a thermal curing, to obtain the oil-containing fiber-polymer self-lubricating composite material.

7. The method as claimed in claim 6, wherein the oil-containing fiber is prepared by a process comprising
impregnating a natural fiber in a lubricating oil, and subjecting the resulting mixture to a solid-liquid separation to obtain the oil-containing fiber,
wherein impregnating a natural fiber in a lubricating oil is performed for 10-30 min.

8. The method as claimed in claim 6, wherein the photocuring adjuvant comprises a reactive diluent and a photoinitiator, and a mass ratio of the precursor compound monomer of the photocurable resin, the reactive diluent, and the photoinitiator is in the range of (10-90):(5-15):(0.5-1.5).

9. The method as claimed in claim 6, wherein ultraviolet light for the ultraviolet curing has a wavelength of 250-420 nm, and an intensity of 30-50 mW/cm², and the ultraviolet curing is performed for 10-30 min.

10. The method as claimed in claim 6, wherein the thermocuring is conducted at a temperature of 25-150° C. for 20-40 min.

11. The oil-containing fiber-polymer self-lubricating composite material as claimed in claim 4, wherein the lubricating oil is one or more selected from the group consisting of liquid paraffin, silicone oil, and polyalpha-olefin PAO10.

12. The method as claimed in claim 8, wherein ultraviolet light for the ultraviolet curing has a wavelength of 250-420 nm, and an intensity of 30-50 mW/cm², and the ultraviolet curing is performed for 10-30 min.

13. The method as claimed in claim 6, wherein the photocurable resin is one or more selected from the group consisting of acrylic acid resin, vinyl polymer, vinyl ether polymer, polyurethane resin, and epoxy resin.

14. The method as claimed in claim 6, wherein the thermosetting resin is one or more selected from the group consisting of polyurethane resin, epoxy resin, vinyl ester resin, and silicone resin.

15. The method as claimed in claim 6, wherein the natural fiber is one or more selected from the group consisting of a cotton fiber, a kapok fiber, and a hemp fiber.

16. The method as claimed in claim 6, wherein the lubricating oil is one or more selected from the group consisting of liquid paraffin, silicone oil, and polyalpha-olefin PAO10.
